(19) United States
(12) Patent Application Publication
(10) Pub. No.: US 2008/0252090 A1
(43) Pub. Date: Oct. 16, 2008

(54) VEHICLE OVERHEAD CONSOLE ASSEMBLY HAVING A DROP DOWN OCCUPANT MIRROR ASSEMBLY

(75) Inventors: John M. Tiesler, Harrison Township, MI (US); Michael C. Dykman, Lake Orion, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/735,698

(22) Filed: Apr. 16, 2007

(51) Int. Cl. B60R 7/04

(52) U.S. Cl. 296/37.7

(57) ABSTRACT

An overhead console assembly, mountable in a vehicle, may have a console body having an exterior surface facing an occupant compartment when mounted in a vehicle and a drop down mirror assembly supported by the console body. The mirror assembly may have a support member having a door panel and a support panel having a support face with a mirror. The mirror assembly has a first position wherein the door panel is generally flush with the exterior surface of the console body with the support panel being generally above the exterior surface of the console body and a second position wherein the door panel, the support panel and mirror are generally below the exterior surface of the console body. The overhead console assembly may have a spring wire member supported between the console body and the mirror assembly for biasing the mirror assembly toward the second position.

### BACKGROUND OF THE INVENTION

1. Field of the Invention

The present invention relates a vehicle overhead console having a drop down occupant mirror assembly.

2. Background Art

The vehicle overhead consoles are known. Vehicle overhead consoles typically comprise a plastic housing having convenience lights and one or more storage compartments. Examples of known overhead consoles can be found in U.S. Pat. Nos. 5,822,023; 6,690,803; and 7,055,883.

### SUMMARY OF THE INVENTION

According to at least one aspect of the present invention, a vehicle overhead console assembly is provided. The vehicle overhead console assembly is mountable in a vehicle having an occupant compartment. In at least one embodiment, the assembly comprises a console body having an exterior surface which would face the occupant compartment when mounted in a vehicle and an opposed interior surface which would face away from the occupant compartment when mounted in a vehicle, and a drop down mirror assembly supported by the console body. In at least one embodiment, the drop down mirror assembly comprises a support member having a generally horizontal door panel and a support panel extending generally transverse from the door panel, with the support panel having a support face supporting a mirror, and the drop down assembly having a first position wherein the door panel is generally flush with the exterior surface of the console body with the support panel being generally above the exterior surface of the console body and a second position wherein the door panel and the support panel and mirror are generally below the exterior surface of the console body. The vehicle overhead console assembly may have a spring wire member supported between the console body and the drop down mirror assembly for biasing the drop down mirror assembly toward the second position.

In at least another embodiment, the vehicle overhead console assembly comprises a console body having an exterior surface facing in a first direction and an interior surface facing in a second direction opposite the first direction, a storage compartment pivotally attached to the console body and being pivotally moveable between an open and a closed position, and a drop down mirror assembly secured to the console body and being linearly moveable between a first stored position and a second in use position. The vehicle overhead console assembly may have a spring wire member supported between the console body and the drop down mirror assembly for biasing the drop down mirror assembly toward the second in use position.

In at least yet another embodiment, the vehicle overhead console assembly comprises a console body having an exterior surface which would face the occupant compartment when mounted in the vehicle and an opposed interior surface which would face away from the occupant compartment when mounted in the vehicle, and a drop down mirror assembly supported by the console body. In at least one embodiment, the drop down mirror assembly comprises a support member having a generally horizontal door panel and a support panel extending generally transverse from the door panel having a support face supporting a convex mirror. The drop down assembly is linearly moveable between a first position with the door panel being generally flush with the exterior surface of the console body and the support panel being generally above the exterior surface of the console body and a second position with the door panel, the support panel, and the mirror being generally below the exterior surface of the console body. The drop down mirror assembly is storable in the first position wherein the mirror is hidden from an occupant and linearly movable to the second position where the mirror is viewable by an occupant. In at least one embodiment, the console assembly further comprises a storage compartment pivotally attached to the console body and pivotally moveable between an open position and a closed position. In at least one embodiment, the vehicle overhead console assembly further comprises a biasing member supported by the console body and providing a downward force on the drop down mirror assembly. At least one latch is provided on one of the drop down mirror assembly and the console body. The at least one latch is selectively engageable and selectively disengageable with at least one striker provided on the other of the drop down mirror assembly and the console body such that at least one of the at least one latch and the at least one striker counteract the downward force on the drop down mirror assembly when the drop down mirror assembly is in the first position.

### BRIEF DESCRIPTION OF THE DRAWINGS

FIG. 1 is a perspective view of an overhead console assembly in accordance with an embodiment of the present invention;

FIG. 2 is a view similar to FIG. 1 showing a component of the overhead console assembly in a use position;

FIG. 3 is another embodiment of the overhead vehicle console illustrated in FIG. 1;

FIG. 4 is an exploded perspective view of another embodiment of an overhead console assembly;

FIG. 5 is a side elevation view of the overhead console assembly of FIG. 4; and

FIG. 6 is an enlarged cross-sectional view of an embodiment of a latch mechanism of FIG. 4.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The Figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within any numerical limits stated is generally preferred. Also, unless expressly stated to the contrary, the description of a group or class of materials by suitably or preferred for a given purpose in connection with the invention implies that mixtures of any two or more members of the group or class may be equally suitable or preferred.

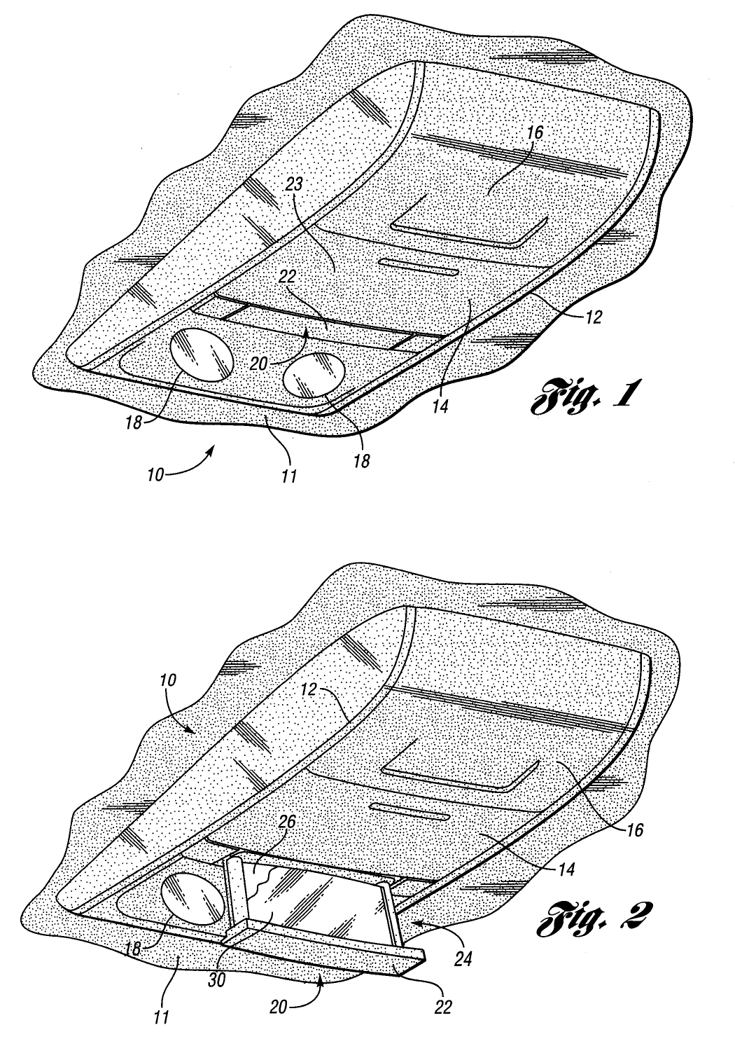

Referring now the Figures, a perspective view of an embodiment of a vehicle overhead console in accordance with at least one embodiment of the present invention is generally shown at 10 in FIG. 1. The vehicle overhead console assembly 10 is adapted to be attached to an interior vehicle roof or headliner schematically illustrated at 11 in a known manner. In a typical vehicle application, the vehicle overhead console assembly 10 is centrally positioned toward a front edge of a vehicle above a vehicle occupant compartment.

The vehicle overhead console assembly 10 includes a console body 12 which may be made of any suitable material but is typically an injection molded plastic component. In at least the illustrated embodiment, one or more exemplary various storage compartment doors 14 and 16 and convenience lights 18 are attached to or supported within the console body 12.

As would be appreciated by those of ordinary skill in the art, the one or more compartment door 14 and 16 can be any conventional pivotally connectable storage bins of various sizes, shapes and design. As would be further appreciated by those of ordinary skill in the art, the vehicle overhead console assembly 10 may be installed in a wide variety of vehicles that may include automobiles, trucks, buses, airplanes, water crafts, trains and the like. Similarly, the vehicle console assembly 10 may be located anywhere within the vehicle for convenient access.

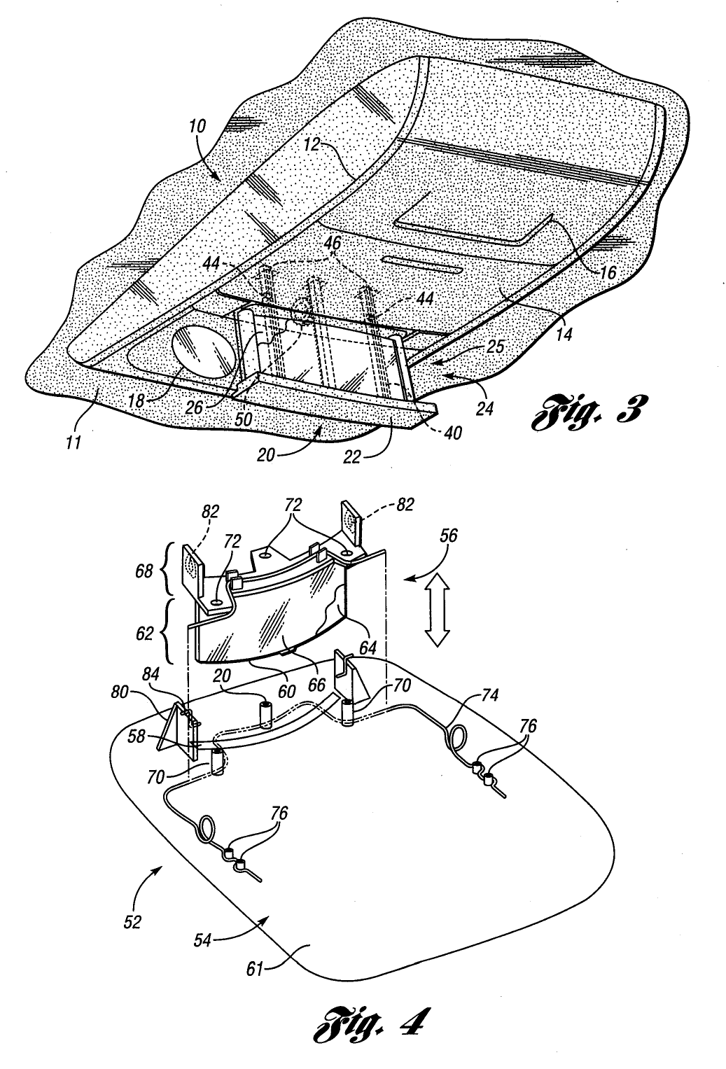

The vehicle overhead console assembly 10 includes a drop down mirror assembly 20. The drop down mirror assembly 20 can be supported by the console body 12 (or mirror casing 25, as shown in FIG. 3, which is supported by the console body 12). Mirror casing 25 can be part of, or separate from, the console body 12. In at least one embodiment, the console body 12 (or casing 25) and/or the mirror assembly 20 include slides and tracks for supporting the mirror assembly 20. The mirror assembly 20 is shown in FIG. 1 in a stowed or stored condition. The drop down mirror assembly 20 includes a door panel 22 which, when the drop down mirror assembly 20 is in its stowed position as illustrated in FIG. 1, is generally adjacent with and flush with the console body 12 and the illustrated storage compartment doors 14 and 16, i.e., the exterior surface 23. The exterior surface, when the console assembly 10 is installed in a vehicle, faces the occupant compartment and a rear, or interior, surface of the console assembly 10 faces the vehicle roof.

The door panel 22 is normally latched with the console body 12 when the drop down assembly 20 is in the stowed or stored position. Any suitable latching mechanism can be employed. In at least one embodiment, the drop down assembly 20 includes a latch mechanism (striker) on the door panel 22 that cooperates with a catch mechanism (latch) on the stationary portion of the console, as is known in the art. The latching mechanism in at least one embodiment comprises a push-push latch mechanism as is known in the art. In at least other embodiments, the latching mechanism could be a magnetic system or a track mechanism.

The drop down mirror assembly 20 includes a support member 24 that is connected with and adjacent the door panel 22. The support member 24 is housable within mirror casing 25. In at least the illustrated embodiment, the support member 24 is generally horizontal. The support member 24 extends generally transverse to the door panel 22. The support member 24 includes a support face 26 upon which a mirror 30 is secured. The support face 26 can be any suitable shape and/or size, however, in at least one embodiment, the support face is 7.5 to 25 cm in length (from one side of the vehicle to the other) and 4 to 10 cm in height.

In at least one embodiment, the mirror is convex to enable a broader view of the vehicle interior. The mirror 30 can be secured to the support face 26 in any suitable manner and in at least one embodiment is secured by a suitable adhesive.

As best shown in FIG. 2, the drop down mirror assembly 20 when disengaged, i.e., unlatched, from the console body 12 (or mirror casing 25) travels generally laterally down from the console 10 into an occupant viewing position to enable passengers in the front passenger compartment to use the mirror 30 to view passengers or objects in the rear of the vehicle. In at least one embodiment, the drop down mirror assembly 20 linearly travels 2 to 12 cm between the stowed and use positions. In this position, the mirror 30 is viewable by the front seat passengers to view other passengers and objects in the rear of the vehicle. In this position, the door panel 22 is 30 to 70 cm below the exterior surface of the console body 12.

In at least one embodiment, as best shown in FIG. 3, the drop down mirror assembly 20 includes spaced apart tracks or guide posts 40 that cooperate with respective guide projections 44 on support panel 24 to guide the linear travel of the drop down mirror assembly 20. In another embodiment, the guide posts 40 are on the mirror casing 25. In at least the illustrated embodiment, each of the guide posts 40 include a channel 46 within which a respective one of the projection 42 is received. The projections 44 are located on the back face of the support panel 24.

The drop down mirror assembly 20 further includes a drive mechanism, schematically shown at 50, for linearly driving the drop down mirror assembly 20 between the stored and in use positions. Any suitable drive and/or dampening mechanism can be used. An exemplary drive mechanism 50 is illustrated in FIG. 3 to comprise a rack and pinion system 50. The rack is connected to the support panel 24 and the pinion is supported within a stationary section of the console 10. It should be understood that the drive mechanism 50 is not limited to a rack and pinion system. Any suitable drive system could be used. Other suitable systems include, but are not limited to, spring, plunger and electro-servo motor systems.

The drop down mirror assembly 20 can be selectively positionable from the stowed or stored position (illustrated in FIG. 1) to the use position (illustrated in FIG. 2). When in the stowed position the drop down mirror assembly 20 is latched in any suitable manner to the console body 12.

To move the drop down mirror assembly 20 to the use position, the drop down mirror assembly 20 is unlatched from the console body 12 and the assembly is allowed to move to the use position. Typically a drive mechanism or some type of biasing member will urge the drop down mirror assembly 20 to the use position. When the drop down mirror assembly 20 is no longer needed an occupant can push on the door panel 20 and return the drop down mirror assembly 20 to be latched with the console body 12 to return the assembly to the stowed position.

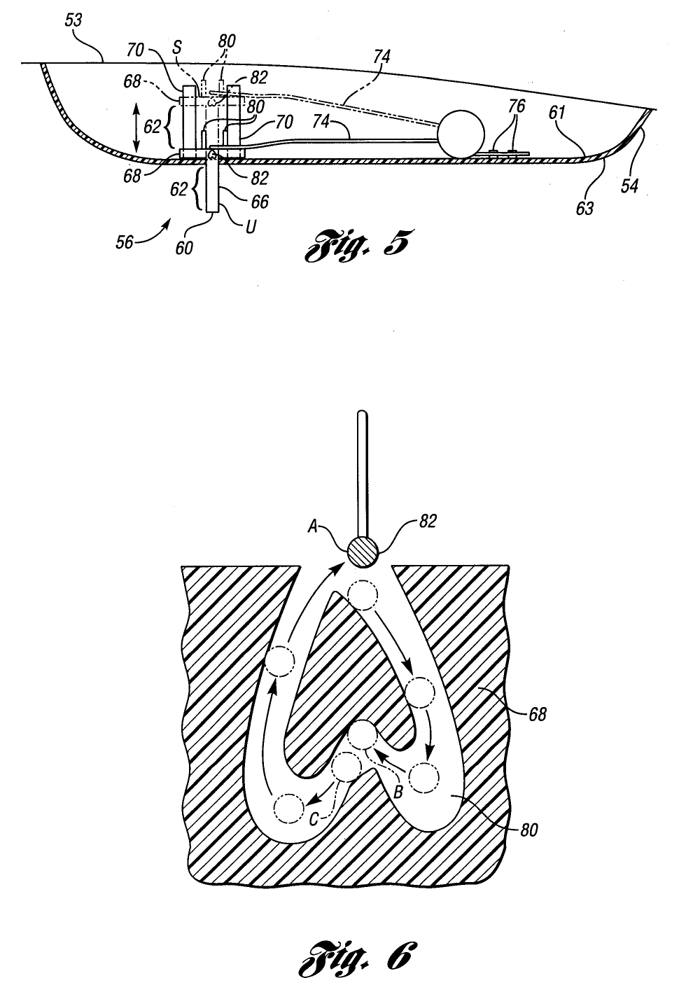

Referring now to FIGS. 4 and 5, another embodiment of a vehicle overhead console assembly is generally referenced by numeral 52. The vehicle overhead console assembly 52 is adapted to be attached to an interior vehicle roof or headliner 53, as illustrated in FIG. 5. The console assembly 52 may have other features incorporated into the console assembly 52, as previously discussed. As illustrated in FIGS. 4 and 5, the console assembly 52 includes a console body 54 which is adapted to be mounted in an overhead area of a vehicle above a vehicle occupant compartment. The console assembly 52 may be made of any suitable material, such as an injection molded plastic.

The console assembly 52 includes a drop down mirror assembly 56, which is supported by the console body 54. The mirror assembly 56 fits through an aperture 58 in the console body 54 so that the mirror assembly 56 can be utilized and/or operated by a vehicle occupant.

The mirror assembly 56 includes a door panel 60 which, when the mirror assembly 56 is in a stowed position S as illustrated in phantom in FIG. 5, is generally adjacent with and flush with an exterior portion 63 of the console body 56. The exterior portion 63, as illustrated in FIG. 5, is opposite an interior portion 61, which is illustrated in both FIGS. 4 and 5.

The mirror assembly 56 includes a support member 62 which is connected to and adjacent the door panel 60. The support member 62 moves between the stowed position S illustrated in phantom in FIG. 5 and an in use position U illustrated in FIG. 5 so that the support member 62 extends beyond the console body 54 when in the use position U. The support member 62 includes a support face 64 which supports a mirror 66 that is viewable by an occupant when the mirror assembly 56 is in the use position U. The mirror 66 may be supported by and/or mounted to the support face 64 in any suitable known manner.

In the embodiments illustrated in FIGS. 4 and 5, the mirror assembly 56 has a connection member 68 which is connected to the support member 62. The connection member 68 mounts the mirror assembly 56 to the console body 54 so that the mirror assembly 56 can translate linearly as indicated by each arrow in FIGS. 4 and 5. The connection member 68 has apertures 72 to aid in mounting the connection member 68 to the console body 54. In one embodiment, the apertures 72 are integrally formed in the connection member 68 of the mirror assembly 56. In another embodiment, the apertures 72 are formed in a secondary punching operation.

The console body 54 has guide posts 70 which may be received by the apertures 72 in the connection member 68 which correspond to the size and location of the guide posts 70 on the console body 54. In one embodiment, the guide posts 70 are integrally formed on the console body 54. As illustrated in FIG. 4, two guide posts 70 are located on one lateral side of the mirror assembly 56 toward opposite transverse sides of the mirror assembly 56 and one guide post 70 is located on an opposite lateral side of the mirror assembly 56 toward the middle of the transverse sides of the mirror assembly 56 to provide increased stability. In one embodiment, the guide posts 70 are integrally formed in the console body 54. In another embodiment, the guide posts 70 are mounted in a secondary mounting operation. Any suitable size, shape, and location for the guide posts 70 is contemplated within the scope of the present invention.

As depicted in FIG. 5, to translate the mirror assembly 56 from the stowed position S to the use position U, a wire spring 74 is mounted on the interior 61 of the console body 54 and on the connection member 68 of the mirror assembly 56. The wire spring 74 provides downward force on the mirror assembly 56. The wire spring 74 is mounted to the console body 54 by posts 76 located at opposite ends of the wire spring 74. Any suitable location and/or size for the posts 76 is contemplated within the scope of the present invention. The wire spring 74 is mounted to the connection member 68 of the mirror assembly 56 by two pairs of guides 78, which are illustrated in FIGS. 4 and 5. Each pair of guides 78 retain the wire spring 74 and allow for some movement of the wire spring 78 as the mirror assembly 56 translates between the stowed position S and use position U. In one embodiment, the guide posts 70 facilitate alignment of the wire spring 74 on the connection member 68.

Supports 80 are provided on opposing transverse sides of the mirror assembly 56. The supports 80 are connected to the console body 54 and are adapted to support the mirror assembly 56. Each support 80 has a striker 84 mounted therein which each interacts with a latch 82 formed in the connection member 68 of the mirror assembly 56. The latch 82 and the striker 84 provide a force on the mirror assembly 56 when the mirror assembly 56 is in the stowed position S. The force provided by the latch 82 and the striker 84 overcomes the downward force provided by the spring wire 74 so that the mirror assembly 56 remains in the stowed position S until released by an outside stimulant, such as a force applied by an occupant. The force applied by the occupant may be an upward force which releases the striker 84 from an engagement with the latch 82 which is discussed in more detail below. In one embodiment, the striker is a wire 84 with a Z shape. Any suitable latch 82 and striker 84 are contemplated within the scope of the present invention.

Referring now to FIG. 6, the latch of FIGS. 4 and 5 is illustrated as an inverted heart-shaped channel and referenced generally by the numeral 82. The heart channel 82 has an appropriate size to receive a portion of the striker 84. In one embodiment, the heart channel 82 is integrally formed in the connection member 68 of the mirror assembly 56. In another embodiment, the heart channel 82 is formed in a secondary forming operation. In the illustrated embodiment, the striker is a wire 84 attached to each of the supports 80. Any suitable channel 82 and wire 84 are contemplated within the scope of the present invention.

When the mirror assembly 56 is in the use position U, illustrated in FIG. 5, the wire 84 is in a first position A as seen in FIG. 6. To move the mirror assembly 56 to the stowed position S, illustrated in phantom in FIG. 5, a user must press the door panel 60 upwards with enough force to overcome the downward force of the wire spring 74. As the user presses the mirror assembly 56 upwards, the wire 84 of FIG. 6 moves through the heart channel 82 to a second position B. In the second position B, the wire 84 is retained within a recessed portion of the heart channel 82. When the wire 84 is in the second position B, wire 84 a counteracting force on the heart channel 82 and the mirror assembly 56 of FIG. 5. The counteracting force provided by the wire 84 on the mirror assembly 56 counteracts the downward force provided by the wire spring 74 of FIG. 5 to allow the mirror assembly to stay in the stowed position S. To move the mirror assembly 56 from the stowed position S to the use position U, the occupant presses the mirror assembly upward. The upward force provided by the occupant moves the wire 84 of FIG. 6 to a third position C. In the third position C, an outer boundary of the heart channel 82 forces the wire 84 through the heart channel 82 back to the first position A. When the wire 84 is in the first position A, the mirror assembly 56 of FIG. 5 is in the use position U.

While embodiments of the invention that have been illustrated and described, it is not intended that these embodiments illustrate and describe all possible forms of the invention. Moreover, the words used in the specification are words of description rather than limitation, and it is understood that various changes may be made without departing from the spirit and scope of the invention.

What is claimed is:

1. A vehicle overhead console assembly mountable in a vehicle having an occupant compartment, the assembly comprising:
a console body having an exterior surface which would face the occupant compartment when mounted in a vehicle and an opposed interior surface which would face away from the occupant compartment when mounted in a vehicle;
a drop down mirror assembly supported by the console body, the drop down mirror assembly comprising a support member having a generally horizontal door panel and a support panel extending generally transverse from the door panel, the support panel having a support face supporting a mirror, the drop down assembly having a first position wherein the door panel is generally flush with the exterior surface of the console body with the support panel being generally above the exterior surface of the console body and a second position wherein the door panel, the support panel and mirror are generally below the exterior surface of the console body; and
a spring wire member supported between the console body and the drop down mirror assembly for biasing the drop down mirror assembly toward the first position.

2. The vehicle overhead console assembly of claim 1 wherein the console body has a latch and the door has a striker that is engageable with the latch to maintain the drop down assembly in the first position.

3. The vehicle overhead console assembly of claim 2 wherein the striker is disengageable with the latch upon depressing the door panel.

4. The vehicle overhead console assembly of claim 1 wherein the drop down assembly travels linearly between the first position and the second position.

5. The vehicle overhead console assembly of claim 4 wherein a linear drive mechanism is provided to effectuate the linear travel of the drop down assembly.

6. The vehicle overhead console assembly of claim 5 wherein the linear drive mechanism comprises a rack and pinion gear.

7. The vehicle overhead console assembly of claim 6 wherein the support panel has projections that engage guide post to guide the movement of the drop down mirror assembly between the first and second positions.

8. The vehicle overhead console assembly of claim 1 wherein the door panel is rectangular in shape.

9. The vehicle overhead console assembly of claim 8 wherein the console body includes a storage compartment that is pivotally attached to the console body and pivotally moveable between an open position and a closed position.

10. A vehicle overhead console assembly comprising:
a console body having an exterior surface facing in a first direction and an interior surface facing in a second direction opposite the first direction;
a storage compartment pivotally attached to the console body and being pivotally moveable between an open and a closed position;
a drop down mirror assembly secured to the console body and being linearly moveable between a first stored position and a second in use position; and
a spring wire member supported between the console body and the drop down mirror assembly for biasing the drop down mirror assembly toward the first stored position.

11. The vehicle overhead console assembly of claim 10 wherein the drop down mirror assembly has a convex mirror which, when the console assembly is mounted in a vehicle, is not viewable by an occupant when the drop down mirror assembly is in the first position and which is viewable by an occupant when the drop down mirror assembly is in the second position.

12. The vehicle overhead console assembly of claim 10 wherein the console body has a latch and the mirror assembly has a door having a striker that is engageable with the latch to maintain the drop down assembly in the first position.

13. The vehicle overhead console assembly of claim 10 wherein the drop down assembly linearly travels 2 to 12 cm between the first and second positions such that the drop down assembly is generally transverse with the exterior surface of the console body when the drop down assembly is in the second position.

14. A vehicle overhead console assembly supportable in a vehicle headliner above an occupant compartment, the assembly comprising:
a console body having an exterior surface which faces the occupant compartment when mounted in the vehicle and an opposed interior surface which faces away from the occupant compartment when mounted in the vehicle;
a drop down mirror assembly supported by the console body, the drop down mirror assembly comprising a support member having a generally horizontal door panel and a support panel extending generally transverse from the door panel, the support panel having a support face supporting a mirror, the drop down assembly being linearly moveable between a first position with the door panel being generally flush with the exterior surface of the console body and the support panel being generally above the exterior surface of the console body and a second position with the door panel, the support panel, and the mirror being substantially below the exterior surface of the console body, the drop down mirror assembly being storable in the first position wherein the mirror is hidden from an occupant and linearly movable to the second position where the mirror is viewable by an occupant;
a biasing member supported by the console body and providing a downward force on the drop down mirror assembly; and
at least one latch provided on one of the drop down mirror and the console body to be selectively engageable and selectively disengageable with at least one striker provided on the other of the drop down mirror and the console body such that at least one of the at least one latch and the at least one striker counteract the downward force on the drop down mirror assembly when the drop down mirror assembly is in the first position.

15. The vehicle overhead console assembly of claim 14 wherein the biasing member further comprises a spring having a first end on a first side of the console body and a second end of a second side of the console body opposite the first side.

16. The vehicle overhead console assembly of claim 14 further comprising:
first and second guides spaced a distance apart and provided on a first lateral side of the drop down mirror assembly; and
a third guide provided on a second lateral side of the drop down mirror assembly;
wherein the first, second and third guides at least partially support the drop down mirror assembly.

17. The vehicle overhead console assembly of claim 14 further comprising a pair of side supports provided on the console body at opposing lateral sides of the drop down mirror assembly, the pair of side supports supporting one of the at least one latch and the at least one striker.

18. The vehicle overhead console assembly of claim 17 wherein the first, second and third guides and the at least a pair of side supports are integrally formed into the console body.

19. The vehicle overhead console assembly of claim 14 further comprising at least one pair of biasing member supports provided on an upper portion of the drop down mirror assembly to at least partially restrict transverse movement of the biasing member.

20. The vehicle overhead console assembly of claim 19 wherein the at least one latch and the at least one pair of biasing member supports are integrally formed into the drop down mirror assembly.
